(19) United States
(12) Patent Application Publication
(10) Pub. No.: US 2019/0050467 A1
(43) Pub. Date: Feb. 14, 2019

(54) Method and System for Content Creation and Management

(71) Applicant: Neerav Parekh, Mumbai (IN)

(72) Inventor: Neerav Parekh, Mumbai (IN)

(21) Appl. No.: 15/759,067

(22) PCT Filed: Sep. 9, 2016
(86) PCT No.: PCT/IN2016/050302

§ 371 Date: Mar. 9, 2018

(30) Foreign Application Priority Data
Sep. 11, 2015 (IN) 800/MUM/2015

(51) Int. Cl. G06F 17/30; G06F 15/18

(52) U.S. Cl. CPC G06F 17/30572; G06F 17/30864; G06F 15/18; G06F 17/30525; G06F 17/30569

(57) ABSTRACT

The present invention relates to a method and system for content creation and management pack analysis, more particularly the 5 invention relates to a content data platform with user interactive features to enhance the user's ability to directly capture and analyse data and information in to a structured form by extracting data and information from un/structured data sources and various formats and generate content.

### BACKGROUND

A. Technical Field

The present invention relates to a method and system for content creation and management pack analysis, more particularly the invention relates to a content data platform with user interactive features to enhance the user's ability to directly capture and analyse data and information in to a structured form by extracting data and information from unstructured data sources and various formats and generate content.

B. Background of the Invention

The content creation technology has developed tremendously over a decade or so. Content creation is the contribution of information to any media and most especially to digital media for an end-user/audience in specific contexts. Content is “something that is to be expressed through some medium, as speech, writing or any of various arts” for self-expression, distribution, marketing and/or publication. Typical forms of content creation include maintaining and updating web sites, blogging, photography, videography, online commentary, the maintenance of social media accounts, and editing and distribution of digital media. A Pew survey described content creation as the creation of “the material people contribute to the information world.”

Content management (CM), is a set of processes and technologies that supports the collection, managing, and publishing of information in any form or medium. When stored and accessed via computers, this information has come to be referred to, simply, as content or, to be precise, digital content. Digital content may take the form of text (such as electronic documents), multimedia files (such as audio or video files), or any other file type that follows a content lifecycle requiring management. The process is complex enough to manage that several large and small commercial vendors such as Interwoven and Microsoft offer content management systems to control and automate significant aspects of the content lifecycle.

Content generation and management has proved to be an expensive affair for businesses operating in the fields of Finance, E-commerce, Legal, Media etc., This prototype conquers human effort thereby reducing the scope of error by replacing it with machine generated content which brings in better efficiency by functioning accurate data analysis, data processing, number crunching resulting into elevated level of data representation

The rise of anonymous and user-generated content presents both opportunities and challenges to Web users. Blogging, self-publishing and other forms of content creation give more people access to larger audiences. But it can also perpetuate rumors and spread information that is not verifiable. It can make it more difficult to find quality content that meets users' information needs.

Digital content is difficult to organize and categorize. Websites, forums and publishers all have different standards for metadata, or information about the content, such as its author and date of creation. The perpetuation of different standards of metadata can create problems of access and discoverability.

The ownership, origin, and right to share digital content can be difficult to establish. On one hand, user-generated content presents challenges to traditional content creators with regard to the expansion of unlicensed and unauthorized derivative works, piracy and plagiarism. On the other hand, the enforcement of copyright laws also make it less likely that works will fall into the public domain.

Also, in this digital age, companies are drowning in data. However, to make sense of the data, they are using dashboards and visualizations. But visualizations are not insight. You need to interpret visualizations to draw insights from them. And to interpret, you need expertise and time. Without expertise and/or time, the insights never get fully understood.

For the reasons stated above, which will become apparent to those skilled in the art upon reading and understanding the specification, there is a need in the art for a system and method for content creation and management for offering better information to a user that is useable, scalable and independent of new technology platforms, uses minimum resources that is easy and cost effectively maintained and is portable and can be deployed anywhere in very little time.

### SUMMARY

The present invention relates to a method and system for content creation and management pack analysis, more particularly the invention relates to a content data platform with user interactive features to enhance the user's ability to directly capture and analyse data and information in to a structured form by extracting data and information from unstructured data sources and various formats and generate content. The system and method thereof of the present invention comprise of a non-transitory processor which is used as a medium to store a set of rules/instructions, which when applied to given data causes the processor to give an output of content in the form of prose in the already set template. The set of instruction/rules, which when applied, causes the processor to select or omit the given data. The set of instructions/rules which when applied, causes the processor to select data for comparison. After the selection of data, the processor further executes set of rules/instructions, which when applied, causes the processor to select the template that needs to be functional to process the sorted data. The processor further executes set of instructions/rules which when applied, causes the processor to select the tone type, define and set variations in phrases associated with those phrases. The processor further executes set of instructions/rules which when applied, causes the processor to select phrases in a pattern to avoid content duplication. The processor further executes set of instructions/rules which when applied, causes the processor to select relevant phrases for relevant comparison. The processor further executes set of instructions/rules which when applied, causes the processor to give an output in a form of display, which will exhibit the selected prose.

### BRIEF DESCRIPTION OF THE DRAWINGS

FIG. 1 depicts the system flow for automatically generating a narrative.

FIG. 2 shows various sources from where structured input data can be taken.

FIG. 3 describes a system where Context Data is collected.

FIG. 4 shows a system flow to identify patterns.

FIG. 5 details a system flow to calculate Derived Data.

FIG. 6 details a system flow to select scenarios.

FIG. 7 describes a system flow to select tone for the narrative.

FIG. 8 describes a system flow for selecting story blueprint

FIG. 9 shows a system flow for generating language.

FIG. 10 is system processor unit block diagram.

FIG. 11 shows a network system using which the system of automatically generating narratives from structured data functions.

FIG. 12 shows a portfolio analysis narration.

FIG. 13 shows adjective determining engine.

FIG. 14 shows flow diagram for persona based live content determination.

FIG. 15 shows flow diagram of overview module.

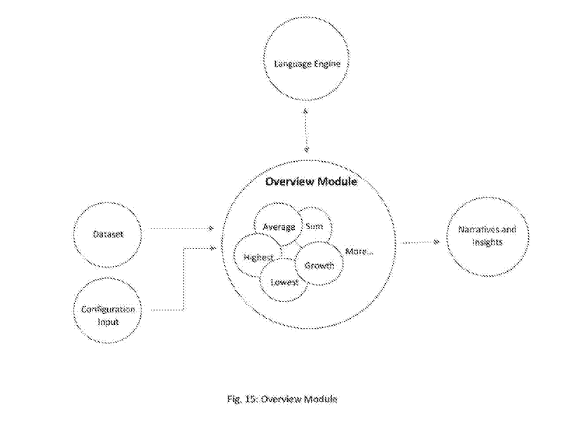

FIG. 16 shows flow diagram of Trend module.

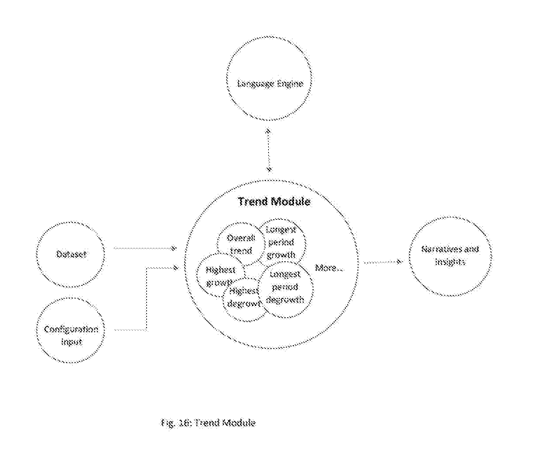

FIG. 17 shows flow diagram of anomaly module.

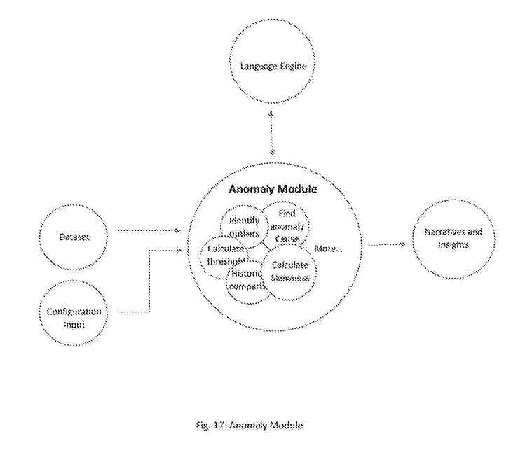

FIG. 18 shows flow diagram of dependability and causality module.

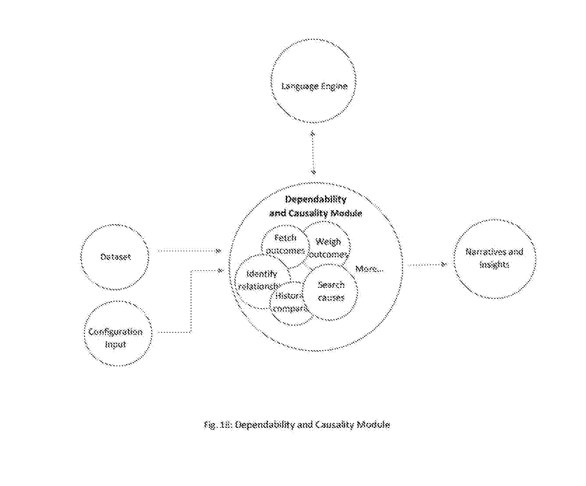

FIG. 19 shows flow diagram of adjective module.

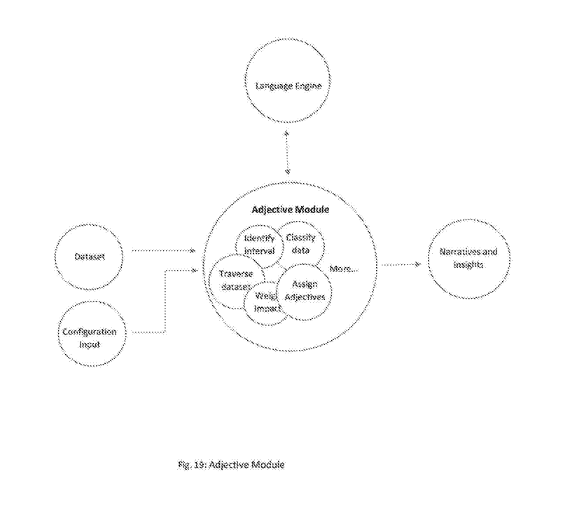

FIG. 20 shows flow diagram of comparative module.

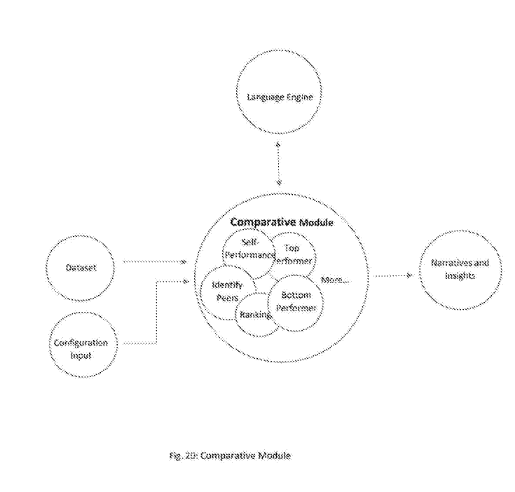

FIG. 21 shows a product description narration.

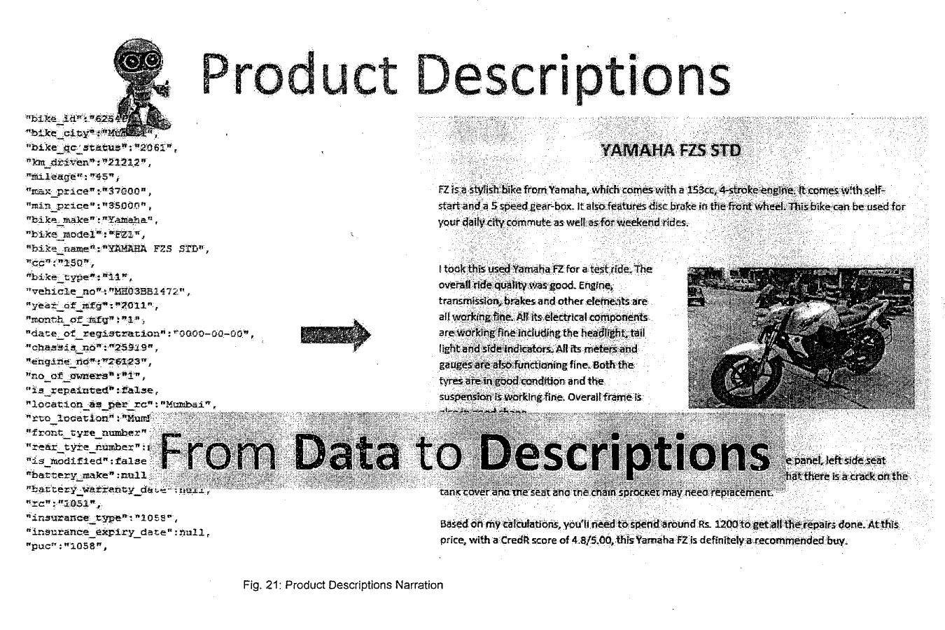

FIG. 22 shows a quarterly earnings data narration.

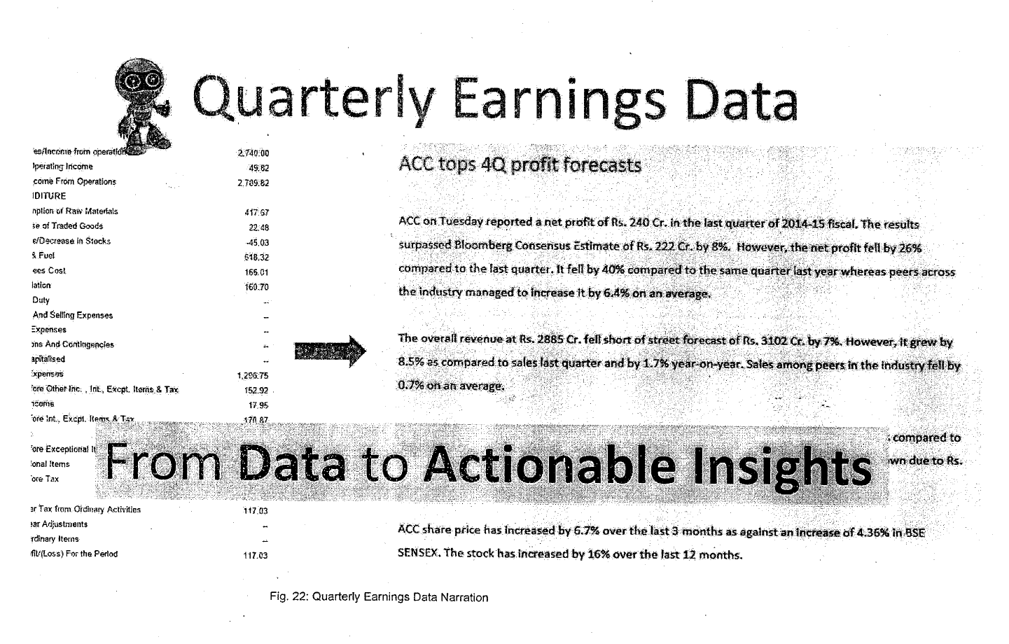

FIG. 23 shows a sales report narration.

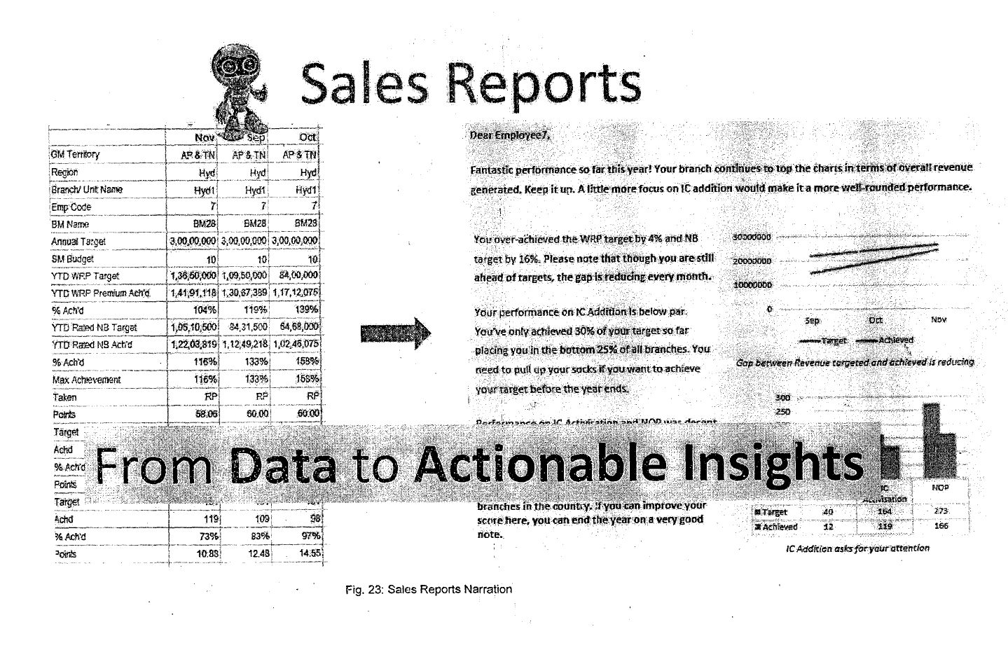

### DETAILED DESCRIPTION OF THE PREFERRED EMBODIMENTS OF THE INVENTION

The invention described herein is directed to perform effective content creation and management through content data platform with user interactive features to enhance the user's ability to directly capture and analyse information in to a structured form by extracting data and information from unstructured data sources and various formats and generate content.

The embodiments herein provide a method and system for content creation and management through content data platform with user interactive features to enhance the user's ability to directly capture and analyse information in to a structured form by extracting data and information from un/structured data sources and various formats to generate and manage content. Further the embodiments may be easily implemented in various data and information management structures. The method of the invention may also be implemented as application performed by a stand alone or embedded system.

The invention described herein is explained using specific exemplary details for better understanding. However, the invention disclosed can be worked on by a person skilled in the art without the use of these specific details.

The systems and methods described herein are explained using examples with specific details for better understanding. However, the disclosed embodiments can be worked on by a person skilled in the art without the use of these specific details.

Throughout this application, with respect to all reasonable derivatives of such terms, and unless otherwise specified (and/or unless the particular context clearly dictates otherwise), each usage of:

“a” or “an” is meant to read as “at least one.”

“the” is meant to be read as “the at least one.”

References in the specification to “one embodiment” or “an embodiment” means that a particular feature, structure, characteristic, or function described in connection with the embodiment is included in at least one embodiment. The appearances of the phrase “in one embodiment” in various places in the specification are not necessarily all referring to the same embodiment.

Hereinafter, embodiments will be described in detail. For clarity of the description, known constructions and functions will be omitted.

Parts of the description may be presented in terms of operations performed by a computer system, using terms such as data, state, link, fault, packet, and the like, consistent with the manner commonly employed by those skilled in the art to convey the substance of their work to others skilled in the art. As is well understood by those skilled in the art, these quantities take the form of data stored/transferred in the form of non-transitory, computer-readable electrical, magnetic, or optical signals capable of being stored, transferred, combined, and otherwise manipulated through mechanical and electrical components of the computer system; and the term computer system includes general purpose as well as special purpose data processing machines, switches, and the like, that are standalone, adjunct or embedded. For instance, some embodiments may be implemented by a processing system that executes program instructions so as to cause the processing system to perform operations involved in one or more of the methods described herein. The program instructions may be computer-readable code, such as compiled or non-compiled program logic and/or machine code, stored in a data storage that takes the form of a non-transitory computer-readable medium, such as a magnetic, optical, and/or flash data storage medium. Moreover, such processing system and/or data storage may be implemented using a single computer system or may be distributed across multiple computer systems (e.g., servers) that are communicatively linked through a network to allow the computer systems to operate in a coordinated manner.

Parts of the description may be presented in terms of operations performed by a computer system, using terms such as data, state, link, fault, packet, FTP and the like, consistent with the manner commonly employed by those skilled in the art to convey the substance of their work to others skilled in the art. As is well understood by those skilled in the art, these quantities take the form of data stored/transferred in the form of electrical, magnetic, or optical signals capable of being stored, transferred, combined, and otherwise manipulated through mechanical and electrical components of the computer system; and the term computer system includes general purpose as well as special purpose data processing machines, switches, and the like, that are standalone, adjunct or embedded.

According to an embodiment of the present invention, the method and system for content creation and management, more particularly the invention relates to a content data platform with user interactive features to enhance the user's ability to directly capture and analyse information in to a structured form by extracting data and information from unstructured data sources and various formats and create content in accordance to the user and/or service provider devices compatible format and to benefit across multiple platforms.

The volume of data and information related to various subject matters has been growing at an exponential rate. Computational processes are widely-used to analyze, understand, integrate, and transform data. For example, to understand trends sports various analysts generally go through an often time-consuming process of iteratively drilling down and rolling up through the different axes to find interesting ‘nuggets’ in the data. Often, to mine data, several algorithms are applied and results are compared, not only among different algorithms, but also among different configurations of a given algorithm to build data warehouses and data marts of the subject matter data and information that integrate data from disparate data sources within an enterprise, extraction, transformation, and loading the data sequences to create consistent, accurate information. This presents a unique problem for digital platforms to create opportunities for content creation and management.

As per one of the embodiment of the present invention, that the present invention may minimize manual intervention and automate extraction of information in un/structured format from all data sources with the ability to directly capture information back in to a structured from.

As per the preferred embodiment of the present invention, the system and the method thereof of will enhance the user's ability to manage and process data for content creation and management.

As per the preferred embodiment of the present invention, the system and the method thereof of is configured to provide information in an efficient and error-free manner, to provide information involving minimal human effort, to breakdown complex data in more understandable prose format which, if necessary, helps to make informed decisions, to reduce the cost implication of converting huge raw data into simple, understandable prose.

As per one of the exemplary preferred embodiment of the present invention, the system and method thereof may takes input—such as financial data or sports details—and fleshes it out to yield reports, summaries and articles. The system and method thereof can produce content much more quickly than a human, which makes them useful for time-sensitive pieces such as sports and financial reports.

As per one of the exemplary preferred embodiment of the present invention, the system and method thereof may rely upon a combination of artificial intelligence (AI), data analytics and machine learning. The system and method thereof learns key concepts and vocabulary specific to the content subject, including typical journalistic terms and phrases, to produce content that can be hard to differentiate from that written by a human.

As per one of the exemplary preferred embodiment of the present invention, the system and method thereof may be configured to perform the steps of establishing the Content piece concept and angle, setting SEO Keywords, generate content, Check that the content is on spec, Check that the content is non plagiarized, Check for SEO, if required Push back for additional points/additional info.

As per one of the exemplary preferred embodiment of the present invention, the system and method thereof may be a task based system that allows to create tasks and subtasks, provide task list for each stage and allows for a reasonable amount of communication and notifications.

As per one of the exemplary preferred embodiment of the present invention, the system and method thereof may be configured to automatically adopt practices and goals and organizational governance structure.

As per one of the exemplary preferred embodiment of the present invention, the system and method thereof may be configured to automatically adopt an inherently collaborative process wherein a Creator may be responsible for creating and editing content, an Editor may be responsible for tuning the content message and the style of delivery, including translation and localization. a Publisher may be responsible for releasing the content for use, an Administrator may be responsible for managing access permissions to folders and files, usually accomplished by assigning access rights to user groups or roles. Admins may also assist and support users in various ways.

As per one of the exemplary preferred embodiment of the present invention, the system and method thereof may be configured to automatically manage versions of content as it evolves.

As per one of the exemplary preferred embodiment of the present invention, the system and method thereof may be configured to automatically create, maintain, and apply review standards.

As per one of the exemplary preferred embodiment of the present invention, the system and method thereof comprise of a non-transitory processor which is used as a medium to store a set of rules/instructions, which when applied to given data causes the processor to give an output of content in the form of prose in the already set template. The set of instruction/rules, which when applied, causes the processor to select or omit the given data. The set of instructions/rules which when applied, causes the processor to select data for comparison. After the selection of data, the processor further executes set of rules/instructions, which when applied, causes the processor to select the template that needs to be functional to process the sorted data. The processor further executes set of instructions/rules which when applied, causes the processor to select the tone type, define and set variations in phrases associated with those phrases. The processor further executes set of instructions/rules which when applied, causes the processor to select phrases in a pattern to avoid content duplication. The processor further executes set of instructions/rules which when applied, causes the processor to select relevant phrases for relevant comparison. The processor further executes set of instructions/rules which when applied, causes the processor to give an output in a form of display, which will exhibit the selected prose.

As per one of the exemplary preferred embodiment of the present invention, the system and method thereof is a set of automated processes that may support the features such as but not limited to import and creation of documents and multimedia material, identification of all key users and their roles, the ability to assign roles and responsibilities to different instances of content categories or types, definition of workflow tasks often coupled with messaging so that content managers are alerted to changes in content, the ability to track and manage multiple versions of a single instance of content, the ability to publish the content to a repository to support access, ability to manage content distributions and digital rights in content life cycle.

As per one of the exemplary preferred embodiment of the present invention, the system and method thereof may be configured to automatically generate and establish a plurality of set of parametric instructions/rules, which when applied to raw data, which may be in form of words, numbers, signs, symbols etc., causes the processor to provide an output in the form of prose presented in the form of descriptions, records, reports or comparative study material.

As per one of the exemplary preferred embodiment of the present invention, the system and method thereof may be configured to automatically generate and establish a plurality of set of parametric instructions/rules, which when applied to raw data, causes the processor to perform various functions to convert raw data into meaningful information in the form of prose presented in the form of report, comparison descriptions, records etc.

As per one of the embodiment, the present invention provides information in an efficient and error-free manner. It provides information involving minimal human efforts. The system and the method thereof breakdown complex data in more understandable prose format which, if necessary, helps to make informed decisions. It also reduces the cost implication of converting huge raw data into simple, understandable prose.

As per the preferred embodiment of the present invention, the system and the method thereof of wherein at least one set of rules/instructions, which when applied, causes the processor to provide with a perspective based on the given data which will be instrumental in providing comparative analysis. The system may be able to refresh all the content previously generated using freshly available data on a periodic basis.

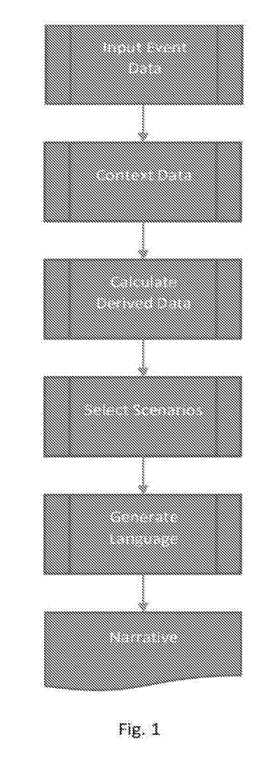

FIG. 1 shows the system for automatically generating a narrative. The system receives at least one event data and then adds a plurality of context data in the form of a plurality of historical data and a plurality of environment data. All this data is then analysed to calculate at least one additional derived metrics. After calculating derived data, the system selects at least one applicable scenarios to build at least one story structure post which it generates language to create the narrative.

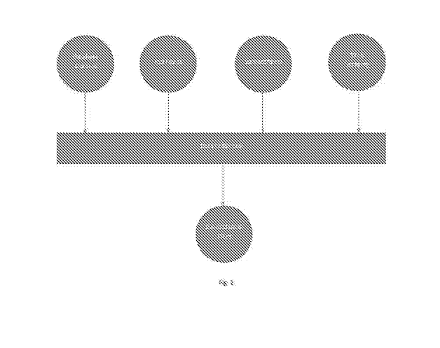

FIG. 2 shows various sources from where at least one structured input data can be taken. The system can take a plurality of input data by querying a database or by reading online RSS feeds. It can also take input in the form of spreadsheets. If required, it can also scrap websites to collect the input data. The input data collected from the above sources is then converted into at least one preferred data-interchange format thus forming the event data for further use. The event data is in the format such that it is easy for humans to read and write and it is easy for machines to parse and generate and transmit data objects.

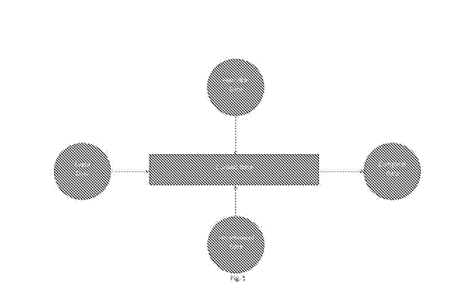

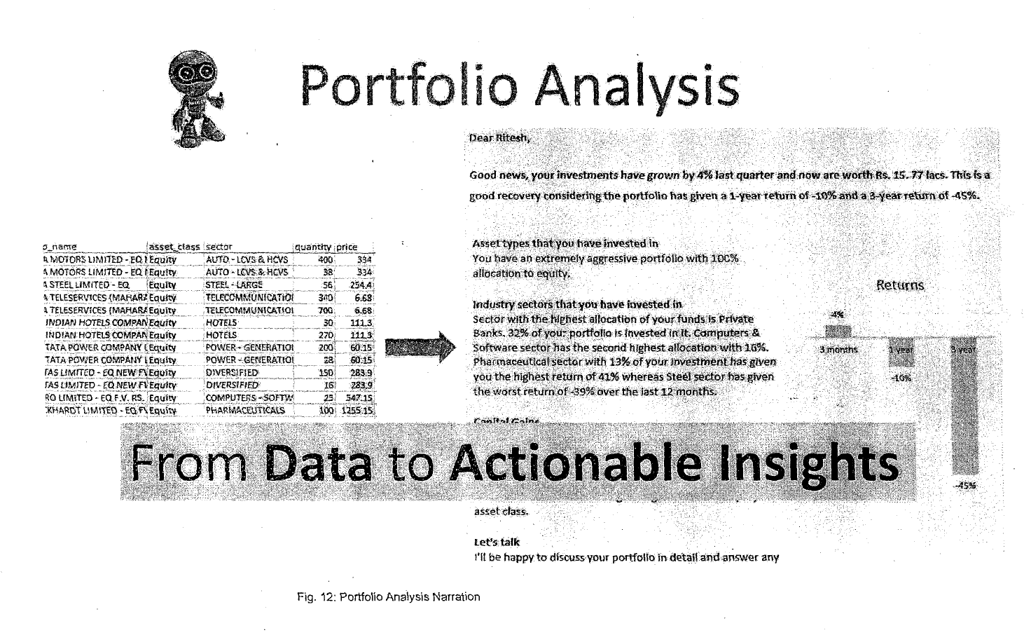

FIG. 3 shows a system where Context Data is collected. Basis the at least one event data, the system takes in a plurality of relevant historical data and a plurality of environment data to provide context to the event data. For example (FIG. 12), while analysing an investment portfolio, client's investment transaction statement serves as the event data. Current prices of peers of the investment instruments in client portfolio is the Environment Data collected and historical prices of the investment instruments present in client portfolio and their peers is the Historical Data collected. All the three data items—event data, historical data and environment data—are combined to form Complete Data.

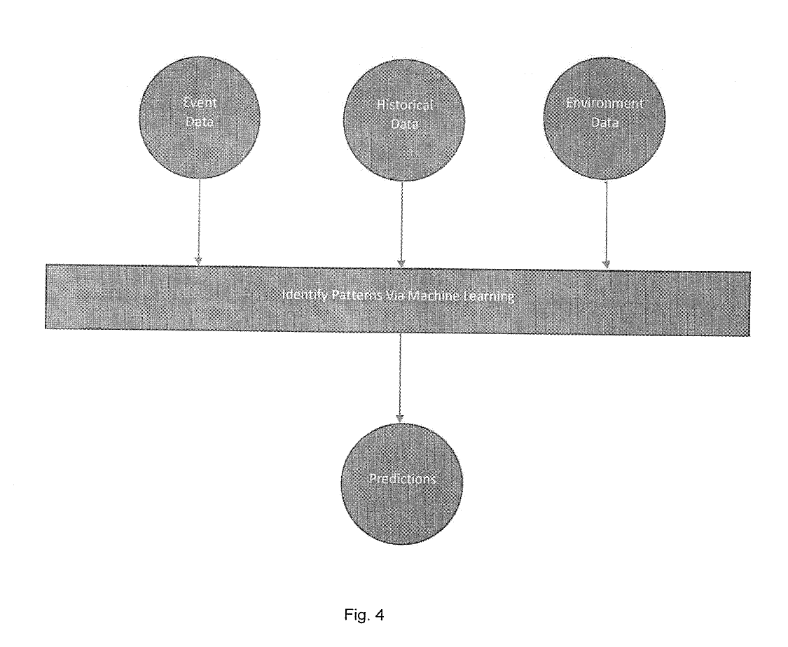

FIG. 4 shows a system where Event Data, Historical Data and Environment Data is used to help identify patterns via Machine Learning. The processor constituting a Machine Learning module is configured to perform the identification of patterns by processing the Event Data, Historical Data and Environment Data. These patterns are then used by the processor to make Predictions.

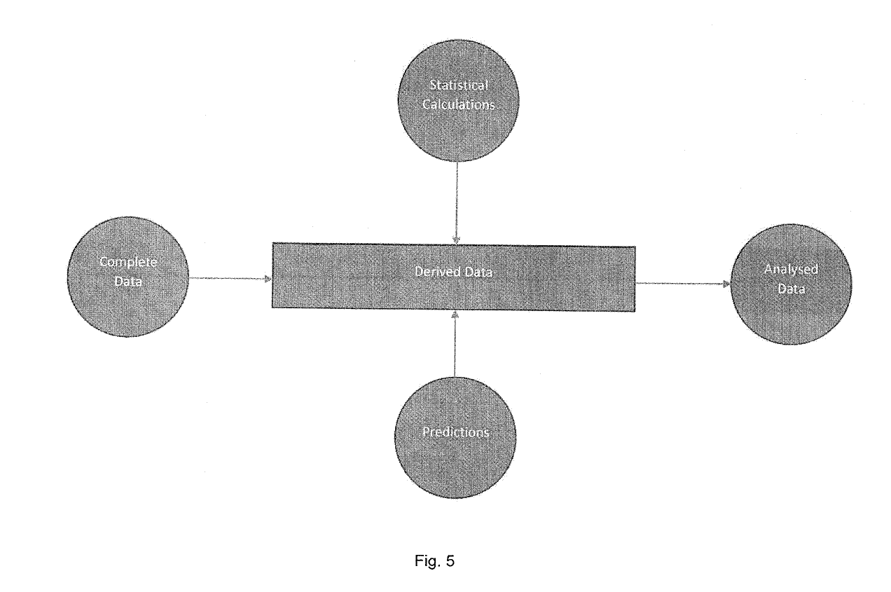

FIG. 5 shows a system to calculate Derived Data. Statistical calculations are performed on Complete Data to which are added Predictions from Machine Learning to arrive at Analysed Data by a processor constituting an analysis module.

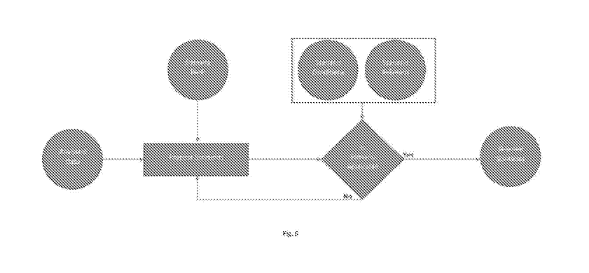

FIG. 6 shows how Scenarios are selected for building the story for the narrative. A list of all Scenarios is maintained in Scenario Bank. The processor constituting the system is configured to perform the process to make at least one scenario wherein from the Scenario bank, one Scenario is taken at a time and checked for its applicability. Applicability is checked basis the conditions for the Scenario and relations between different Scenarios. Once all the Scenarios are checked for applicability, a list of Scenarios that have passed is made.

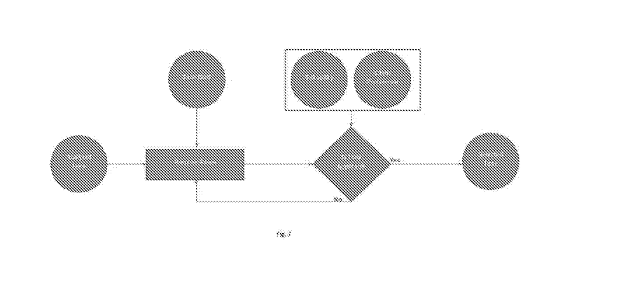

FIG. 7 shows how a Tone is selected for the narrative. A list of Tones is maintained in Tone Bank. The processor constituting the system is configured to perform the process to select at least one Tone wherein a Tone is taken at a time to check for its applicability. Applicability is tested basis the suitability of Tone for the underlying information and Client Preference. If the underlying information is negative, the narrative tone has to sound negative. However, if the client wants negative information also to be conveyed in a positive or neutral tone, then his preference overrides suitability. After checks, one most applicable tone is selected.

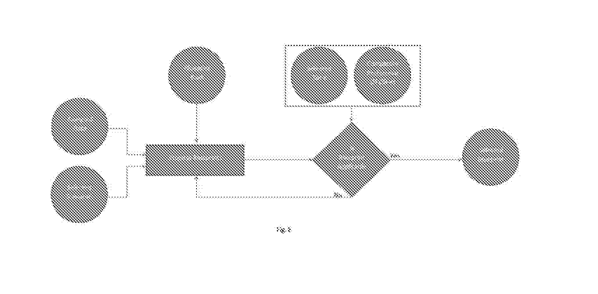

FIG. 8 shows a system for selecting story blueprint. Blueprints differing on the basis of their tone and complexity of the storyline are maintained in a bank. The processor constituting Blueprint selection module of the Language generation module is configured to perform the process of selection of blue print wherein for the analysed data received and the selected scenarios received one blueprint is selected from this bank basis the Tone selected as per FIG. 7 and the preference of client.

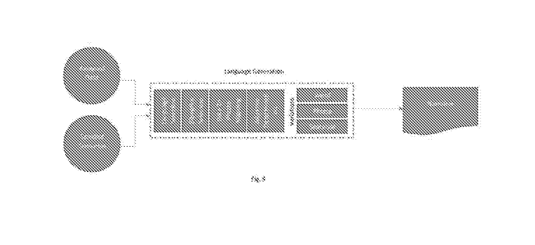

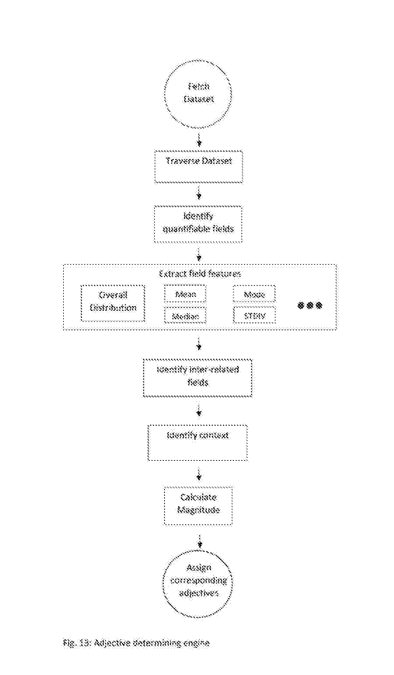

FIG. 9 shows a system for generating language. The first step in generating language is to select blueprint as described in FIG. 8. Next step is to map data to phrases. The last step is to change words, phrases and sentences to ensure that narratives produced are unique in language and don't sound repetitive wherein the adjective determining engine (FIG. 13) implemented at the processor of the Data to phrase mapping module of the language generation module is configured to fetch the dataset. It traverses the dataset and identifies quantifiable fields. It processes the quantifiable fields to extract field features such as overall distribution, mean, median, mode, standard deviation etc. It identifies the interrelated fields, identifies context and determines the magnitude based on which assignment of corresponding adjectives is performed.

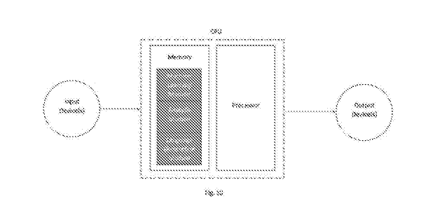

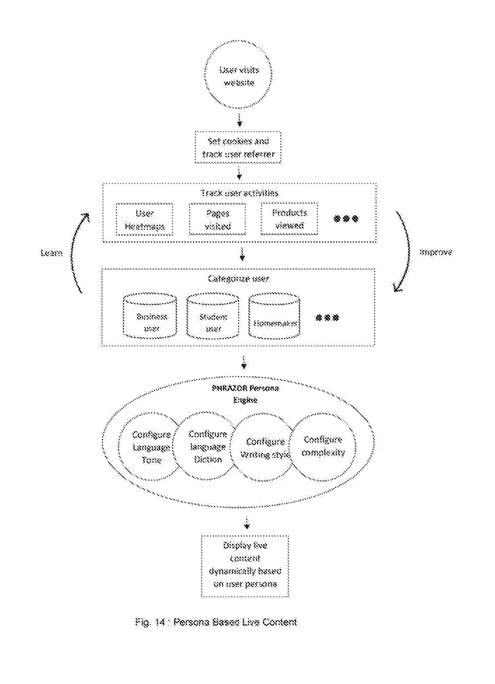

FIG. 10 shows processor unit block diagram wherein the system includes multiple hardware components storing multiple software components of a system that automatically converts structured data into narratives. The processor of the system is configured to synchronize various modules constituting the system and execute the associated functions. The processor is configured to communicate and interface with client device, client database and third party database over the wired or wireless network. The processor of the system is configured to provide persona based live content (refer FIG. 14).

The processor of the system is configured to provide persona based live content wherein the processor set cookies and track at least one user referrer when at least one user visits website. The processor tracks the at least one user activities such as user hit-maps, pages visited, products viewed etc. Based on the tracked information the plurality of users are categorized by the processor. The persona engine implemented at the processor, interacts with at least one persona reusable module implemented at the processor and other respective modules of the system to display live content dynamically based on user persona by configuring language tone, configuring language direction, configuring writing style and configuring complexity.

The persona reusable module implemented at the processor comprise of overview module, Trend module, anomaly module, dependability and causality module, correlation module, adjective module, comparative module, team module all of which are pre-defined configurable pattern blocks that can be used for various kinds of dataset. The overview module processes the received dataset and the received configuration input in interaction with language generation module to provide the overall status of the scenario, narratives and insights wherein the status includes the parameters such as but not limited to average, highest, lowest growth etc. The trend module processes the received dataset and the received configuration input in interaction with language generation module to provide the overall trend of the scenario, narratives and insights wherein the trend includes the parameters such as but not limited to overall trend, highest growth, highest degrowth, longest period growth, longest period degrowth etc. The anomaly module processes the received dataset and the received configuration input in interaction with language generation module to identify outliers, to calculate threshold, to determine historic comparisons, to calculate skewness etc. to provide narratives and insights. The dependability and causality module processes the received dataset and the received configuration input in interaction with language generation module to fetch outcomes, to identify relationships, to determine historic comparisons, to weigh outcomes etc. to provide narratives and insights. The adjective module processes the received dataset and the received configuration input in interaction with language generation module to identify intervals, to traverse dataset, to classify data, to assign adjectives, to weigh impacts etc. to provide narratives and insights. The comparative module processes the received dataset and the received configuration input in interaction with language generation module to identify peers, to compare self-performance, to determine ranking etc. to provide narratives and insights.

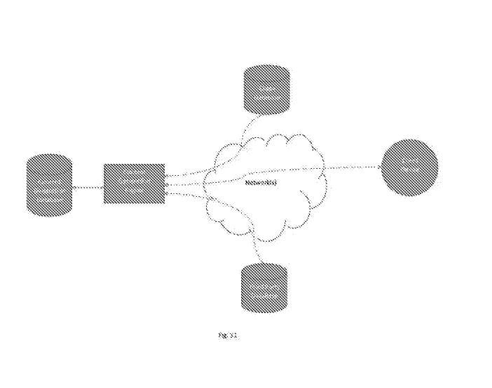

FIG. 11 shows a network system using which the system of automatically generating narratives from structured data functions to collect data, process it and then deliver narratives to client machines.

The present invention may overcome the challenges of the current scenario through the described system and method for content creation and management through content data platform with user interactive features to enhance the user's ability to directly capture and analyse information in to a structured form by extracting data and information from un/structured data sources and various formats and generate content.

1. A method for content creation and management, the method comprising steps of:
receiving at least one structured input data;
converting the input data collected form event data;
extracting and providing a plurality of context data, basis at least one event data;
identifying a plurality of patterns via machine learning and arrive at analyzed data;
selecting scenarios for the narrative by a processor constituting the system;
selecting tone for the narrative by a processor constituting the system;
selecting at least one story blueprint for the narrative by a processor constituting Blueprint selection module of the Language generation module
generating language, the generating language comprising steps of:
adopting the selected blueprint selected by the Blueprint selection module;
mapping the data to phrases;
changing words, phrases and sentences to ensure
that narratives produced are unique in language;
providing narratives at the output devices.

2. The method of claim 1 wherein at least one structured input data is received by querying a database or via RESTFUL API or by reading online RSS feeds, taking input in the form of spreadsheets, and scraping websites to collect the input data.

3. The method of claim 1 wherein at least one structured input data received is converted to form event data by converting the input data in to at least one preferred data-interchange format thus forming the event data that it is easy for humans to read and write and it is easy for machines to parse and generate and transmit data objects.

4. The method of claim 1 wherein extracting and providing a plurality of context data is performed by extracting basis the at least one event data, a plurality of relevant historical data and a plurality of environment data.

5. The method of claim 1 wherein complete data is formed by combining event data, historical data and environment data.

6. The method of claim 1 wherein identifying a plurality of patters via machine learning and arriving at analyzed data is performed by processing the Event Data, Historical Data and Environment Data.

7. The method of claim 1 wherein derived data is calculated by performing Statistical calculations on Complete Data to which are added Predictions from Machine Learning so as to arrive at Analyzed Data.

8. The method of claim 1 wherein scenarios for the narrative are made, by taking one Scenario at a time from Scenario Bank and checking for its applicability basis the conditions for the Scenario and relations between different Scenarios. Once all the Scenarios are checked for applicability, a list of Scenarios that have passed is made.

9. The method of claim 1 wherein tone for the narrative are selected, by taking one tone taken at a time to check for its applicability basis the suitability of Tone for the underlying information and Client Preference.

10. The method of claim 1 wherein for the analyzed data received and the selected scenarios received, at least one blueprint is selected from the bank basis the Tone selected and the preference of client.

11. The method of generating language as claimed in claim 1 wherein the adjective determining engine is configured to perform the steps of:
fetching the dataset;
traversing the dataset and identifies quantifiable fields;
processing a plurality of quantifiable fields to extract field features such as overall distribution, mean, median, mode, standard deviation etc.
identifying a plurality of interrelated fields;
identifying context and determining the magnitude to perform the assignment of corresponding adjectives.

12. The method of generating language as claimed in claim 1 wherein persona based live content are provided by performing steps of:
setting cookies and tracking at least one user referrer when at least one user visits website;
tracking the at least one user activities such as user hit-maps, pages visited, products viewed etc.;
categorizing the plurality of users based on the tracked information;
displaying live content dynamically based on user persona by configuring language tone, configuring language direction, configuring writing style and configuring complexity

13. The method as claimed in claim 1 and claim 12 wherein an overview module processes the received dataset and the received configuration input in interaction with language generation module to provide the overall status of the scenario, narratives and insights, the status includes the parameters such as but not limited to average, highest, lowest growth etc.

14. The method as claimed in claim 1 and claim 12 wherein a trend module processes the received dataset and the received configuration input in interaction with language generation module to provide the overall trend of the scenario, narratives and insights, the trend includes the parameters such as but not limited to overall trend, highest growth, highest degrowth, longest period growth, longest period degrowth etc.

15. The method as claimed in claim 1 and claim 12 wherein an anomaly module processes the received dataset and the received configuration input in interaction with language generation module to identify outliers, to calculate threshold, to determine historic comparisons, to calculate skewness etc. to provide narratives and insights.

16. The method as claimed in claim 1 and claim 12 wherein a dependability and causality module processes the received dataset and the received configuration input in interaction with language generation module to fetch outcomes, to identify relationships, to determine historic comparisons, to weigh outcomes etc. to provide narratives and insights.

17. The method as claimed in claim 1 and claim 12 wherein an adjective module processes the received dataset and the received configuration input in interaction with language generation module to identify intervals, to traverse dataset, to classify data, to assign adjectives, to weigh impacts etc. to provide narratives and insights.

18. The method as claimed in claim 1 and claim 12 wherein a comparative module processes the received dataset and the received configuration input in interaction with language generation module to identify peers, to compare self-performance, to determine ranking etc. to provide narratives and insights.

19. A system for content creation and management, the system comprises:
a content generation database;
a plurality of client database;
a plurality of client devices;
a plurality of third party databases; and
a content generation engine, the content generation engine comprises a processor unit, the processor unit comprises:
a processor constituting a Machine Learning module, the processor constituting a Machine Learning module configured to perform the identification of patterns to make predictions by processing the Event Data, Historical Data and Environment Data;
a processor constituting an analysis module, the processor constituting an analysis module configured to calculate derived data by performing Statistical calculations on Complete Data to which are added Predictions from Machine Learning so as to arrive at Analysed Data;
a processor constituting Blueprint selection module of a Language generation module is configured to perform the process of selectin blue print
an adjective determining engine implemented at the processor of the Data to phrase mapping module of a language generation module
a processor constituting data to phrase mapping module;
a processor comprising persona reusable module, the processor configured for:
capturing input data and processing it to form event data;
selecting scenarios for the narrative;
selecting tone for the narrative;
performing the process to make at least one scenario;
performing the process to select at least one Tone;
communicating and interfacing with client device, client database and third party database over the wired or wireless network;
provide persona based live content; and
synchronize various modules constituting the system and execute the associated functions.

20. The system as claimed in claim 19, wherein persona engine implemented at the processor, interacts with at least one persona reusable module implemented at the processor and other respective modules of the system to display live content dynamically based on user persona by configuring language tone, configuring language direction, configuring writing style and configuring complexity.

21. The system as claimed in claim 19, wherein the persona reusable module implemented at the processor comprise of overview module, Trend module, anomaly module, dependability and causality module, correlation module, adjective module, comparative module, team module.
